(19) United States
(12) Patent Application Publication
(10) Pub. No.: US 2008/0029131 A1
(43) Pub. Date: Feb. 7, 2008

(54) Device for operating a conveying dishwashing machine

(76) Inventor: Engelbert Ecker, Offenburg (DE)

Correspondence Address: MG-IP Law, PLLC, P.O. BOX 1364, FAIRFAX, VA, 22038-1364, US

(21) Appl. No.: 11/882,467

(22) Filed: Aug. 1, 2007

Related U.S. Application Data
(63) Continuation of application No. PCT/EP06/00117, filed on Jan. 10, 2006.

(30) Foreign Application Priority Data
Feb. 1, 2005 (DE) DE 10 2005 004300

(51) Int. Cl. B08B 3/02; B08B 13/00

(52) U.S. Cl. 134/57 D; 134/56 D; 134/72

(57) ABSTRACT

A conveyor dishwasher is provided with a transporting arrangement for transporting wash ware through a plurality of treatment zones through which the wash ware is transported in the transporting direction. At least one of spray systems provided in the treatment zones can be moved relative to the transporting direction of the wash ware.

This nonprovisional application is a continuation of International Application No. PCT/EP2006/000117, which was filed on Jan. 10, 2006, and which claims priority to German Patent Application No. DE 102005004300, which was filed in Germany on Feb. 1, 2005, and which are both herein incorporated by reference.

### BACKGROUND OF THE INVENTION

1. Field of the Invention

The present invention relates to a method of transporting wash ware through a conveyor dishwasher, and to a conveyor dishwasher in which the wash ware is transported continuously.

2. Description of the Background Art

WO 00/53076 A1 discloses a conveyor dishwasher which comprises a washing zone and a rinsing zone, items which are to be cleaned being conveyed through the dishwasher and being sprayed with a cleaning solution within the washing zone. The cleaned crockery is rinsed in the zone following the washing zone. The dishwasher is driven such that it operates cyclically, in which case, within an operating cycle, a transporting belt is driven at a normal speed and cleaning solution is fed to the washing zone, whereas clean water is fed to the rinsing zone. Within an idling cycle, the conveying arrangement, in the form of a transporting belt, is stopped and the supply of clean water to the rinsing zone is interrupted.

The dishwasher known from WO 00/53076 A1 comprises a washing zone, a rinsing zone and a transporting belt for conveying items through the dishwasher as well as feed arrangements for feeding cleaning solution to the washing zone and also nozzles for spraying rinsing water within the rinsing zone. Also provided is a control arrangement for controlling the dishwasher, the control arrangement controlling the transporting arrangement cyclically. A timer for controlling the washing cycles achieves the situation where, while items are conveyed in the conveying direction on the transporting belt, cleaning solution is simultaneously fed to a washing zone and clean water is conveyed to the rinsing zone. During a pause cycle, the transporting belt, with the items accommodated thereon, is at a standstill, while the feed of clean water to the rinsing zone remains interrupted.

According to this solution, with the exception of a transporting belt arranged at the inlet and at the outlet, the conveyor dishwasher has a single transporting belt passing through it. Movement through all zones, be it the washing zone, the cleaning zone or a rinsing zone, takes place at the same speed. This solution proposes cyclic, non-continuous transportation of the items which are to be cleaned in the conveyor dishwasher, rapid transportation resulting in short durations of action of the cleaning fluid, whereas long durations of action can be achieved when the transporting arrangement is stopped. In other commercially available machines, the wash ware is transported continuously through the machine. In these machines, the slowest processing zone predetermines the transporting speed for the rest of the zones in the machine.

In conveyor dishwashers, for example the rinsing step requires a minimum quantity of water to be applied to the wash ware within the shortest period of time in order to produce a sufficiently thick film of water to wash away particles. At lower transporting speeds of a transporting arrangement, for example of a transporting belt moving continuously through the conveyor dishwasher, too much rinsing water is consumed in relation to the number of wash-ware items in each case because the wash ware remains for a relatively long period of time in the clean-water rinsing region.

### SUMMARY OF THE INVENTION

It is therefore an object of the present invention to provide a conveyor dishwasher in which, with a continuous transporting speed of a transporting arrangement, it is possible to optimize the duration of dishwashing, rinsing or drying phases.

Following the solution proposed according to the invention, in one of the treatment zones of a conveyor dishwasher, a direct-action spray device for introducing a cleaning medium, or a dishwashing system, is moved relative to the direction in which the wash ware is transported through the conveyor dishwasher. The relative movement of the direct-action spray system for a cleaning medium, or of a dishwashing system, for applying clean water and dishwashing liquid can take place both in and counter to the direction in which the wash ware is transported through the treatment zones of the conveyor dishwasher.

According to an aspect of the solution proposed according to the invention, a spray system or dishwashing system which acts from both sides on the wash ware transported through the conveyor dishwasher may be accommodated on a carriage, which, by means of a separate, independent drive, can be displaced relative to the transporting arrangement, for example a circulating transporting belt. According to this aspect, limit switches can sense the displacement distance in both directions of the carriage, which accommodates the dishwashing system, spray system, which can be moved relative to the transporting arrangement, or the direct-action spray system. The limit switches, which are provided at the end points of the respective displacement distance in the displacement direction of the carriage, are connected to a machine controller. The first limit switch can sense, for example, the time taken for the wash ware to reach the first limit switch. The transporting speed of the wash ware can be calculated therefrom, by the machine controller. In dependence on the transporting speed determined, the separate, carriage-driving drive can then be operated and for example the clean-water dishwashing system, which is accommodated on the carriage, can be displaced either in or counter to the direction in which the wash ware is transported through the conveyor dishwasher. This advantageously achieves the situation where conveyor dishwashers can make considerable savings in terms of clean water and heat energy required for heating up the clean water and also detergents, i.e. chemicals introduced. The first limit switch senses not just the transporting speed of the wash ware through the conveyor dishwasher but also, at the same time as the separate drive for the carriage is operated, a pump which delivers heated-up clean water and operates a solenoid valve. The machine controller optimizes the movement speed of the carriage in dependence on the value which has been calculated in the machine controller for the speed at which the wash ware is transported through the conveyor dishwasher.

If, for example, the carriage is arranged within the rinsing zone of the conveyor dishwasher, the carriage accommodates clean-water rinsing systems which wet the wash ware from the top side and the underside. If the carriage passes into a position which can be established by a second limit switch, the separate drive can be reversed as a result of the second limit switch being reached, in which case the carriage and the clean-water rinsing systems accommodated therein resume their starting position in the region of the first limit switch. At the same time as the now rinsed wash ware reaches the second limit switch, the rinsing function can be switched off, i.e. the machine controller controls the solenoid valve for supplying clean water to a pump provided in the rinsing zone of a conveyor dishwasher.

In a further aspect of the invention, a direct-spray system or a dishwashing system, for example a clean-water rinsing system, can be pivoted about a pivot axis within a corresponding treatment zone of the conveyor dishwasher. It is also the case with this variant that the system is then assigned separately operable drives relative to the wash-ware-accommodating transporting arrangement of the conveyor dishwasher. According to this variant, the pivoting movement of the dishwashing system or the direct-spray system is sensed by detectors. In dependence on the wash ware reaching a first detector, the pivoting drive is activated and, once the wash ware has passed through the corresponding treatment zone, detected by a second detector arranged at the end of the treatment zone, can also be switched off again. In respect of, for example, supplying clean water to such a dishwashing system, reference is made to what has been discussed in relation to the first variant.

As a result of the wash ware reaching the first detector, it is also possible, according to this variant, for the machine controller to calculate the speed at which the wash ware is transported through the conveyor dishwasher. The movement speed, i.e. the angular speed of the spray systems about the pivot axis, can be predetermined in optimized fashion in dependence on the value calculated for the transporting speed.

The above variants of the idea on which the invention is based, regardless of whether they are used in a dishwashing zone, a pump-action rinsing zone or a clean-water rinsing zone, can be used to achieve respectively durations of action as well as quantities of water and quantities of detergent which, on the one hand, reduce the quantity of water consumed by the conveyor dishwasher, on the other hand limit the heat energy to the amount which is absolutely necessary and, finally, considerably reduce the introduction of chemicals into the dishwasher proposed according to the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a section through a conveyor dishwasher having clean-water spray systems with a separate drive which are arranged on a displaceable carriage; and

FIG. 2 shows an illustration of a treatment zone of a conveyor dishwasher with pivotably arranged spray systems in the top and in the bottom regions of the schematically illustrated treatment zone.

### DETAILED DESCRIPTION

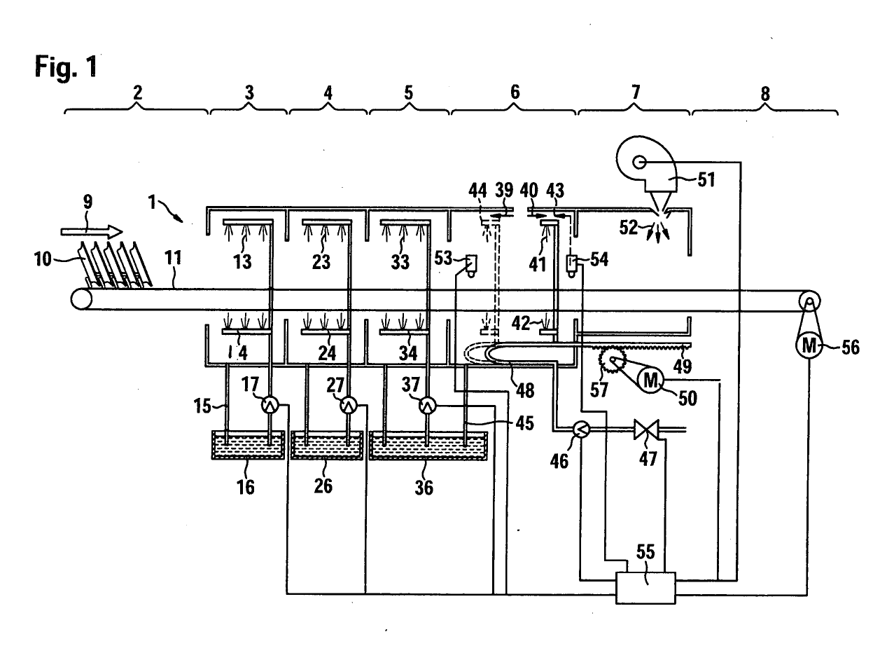

The illustration according to FIG. 1 shows a section through a conveyor dishwasher which has a plurality of treatment zones for wash ware, a spray system which can be moved relative to the wash ware being arranged in one of the treatment zones. A conveyor dishwasher 1 comprises an inlet region 2, within which wash ware 10 is positioned on a transporting arrangement 11. The transporting arrangement 11 may be configured as a circulating conveying belt, which is driven by a drive 56. On the one hand, the wash ware 10 may be positioned directly on the continuously moving transporting arrangement 11; on the other hand, it is also possible to position transporting racks on the transporting arrangement 11, these racks containing respectively presorted wash ware 10. Located downstream of the inlet region 2 of the conveyor dishwasher 1 is a preliminary cleaning zone 3, which has at least one washing zone 4 arranged downstream of it. The at least one washing zone 4 is followed by a pump-action rinsing zone 5, which is followed, in turn, by a clean-water rinsing zone 6. The wash ware 10, which following passage through the clean-water rinsing zone 6 has been cleaned and rinsed, passes into a drying zone 7, in which the wash ware 10 is dried and, if appropriate, cooled, in which case it can be removed again by the transporting arrangement 11 within the outlet region 8. The direction in which the wash ware 10 is transported through the abovementioned treatment zones of the conveyor dishwasher 1 is designated 9, and the conveying speed at which the wash ware 10 is transported, in the transporting direction 9, through the treatment zones of the conveyor dishwasher 1 is dependent on the drive 56.

The preliminary cleaning zone 3, according to the illustration in FIG. 1, contains a top preliminary-cleaning spray system 13 and a bottom preliminary-cleaning spray system 14. Located beneath the bottom preliminary-cleaning spray system 14 is a return means 15, which opens out into a tank 16 of the preliminary cleaning zone 3. The cleaning fluid which is sprayed onto the wash ware 10 within the preliminary cleaning zone 3 is delivered by a pump 17 which takes in cleaning fluid from the tank 16 of the preliminary cleaning zone 3. The pump 17 is connected to a machine controller 55 of the conveyor dishwasher 1.

The preliminary cleaning zone 3 has a washing zone 4 arranged downstream of it. Instead of the one washing zone 4 which is illustrated in FIG. 1, it is also possible for the conveyor dishwasher 1 to have a plurality of washing zones 4 arranged one behind the other. The washing zone 4 which is illustrated in FIG. 1 comprises a top spray system 23 and a bottom spray system 24. Beneath the bottom spray system 24, a return means 25 is located in a tank 26, which collects the cleaning fluid applied to the wash ware 10 in the washing zone 4. A pump 27 takes in the cleaning fluid from the tank 26 and delivers it to the top spray system 23 and to the bottom spray system 24. It is also the case that the pump 27 within the at least one washing zone 4 of the conveyor dishwasher 1 is connected to the machine controller 55.

The at least one washing zone 4 of the conveyor dishwasher 1 has the pump-action rinsing zone 5 arranged downstream of it. The pump-action rinsing zone 5 contains a top pump-action rinsing system 33 and a bottom pump-action rinsing system 34. A return means 35 extends into a tank 36 from the bottom pump-action rinsing system 34. A pump 37 takes in cleaning fluid from the tank 36 and delivers it, in turn, to the top pump-action rinsing system 33 and to the bottom pump-action rinsing system 34. It is also the case that the pump 37 arranged in the pump-action rinsing zone 5 is connected to the machine controller 55 of the conveyor dishwasher 1.

The pump-action rinsing zone 5 has a clean-water rinsing zone 6 arranged downstream of it.

A top clean-water rinsing system 41 and a bottom clean-water rinsing system 42 are arranged within the clean-water rinsing zone 6. By virtue of the clean-water rinsing systems 41, 42, the wash ware 10 accommodated on the transporting arrangement 11 is transported through the clean-water rinsing zone 6 in the transporting direction 9. In that variant of the conveyor dishwasher 1 which is illustrated in FIG. 1, the clean-water rinsing systems 41, 42 are designed for movement relative to the transporting arrangement 11, which is designed as a circulating belt. Although illustrated in FIG. 1 in conjunction with the clean-water rinsing zone 6, it is also possible for the spray systems 23 and 24 arranged in the pump-action rinsing zone 5, and for dishwashing systems accommodated in further washing zones 4, to be designed such that the dishwashing systems arranged in the treatment zones mentioned in each case can be moved relative to the transporting arrangement 11, on which the wash ware 10 is accommodated; this also applies to the direct-action spray system.

It is also the case that, following the concept proposed according to the invention, it is possible for the direct-action spray systems, with which for example a more highly concentrated detergent is introduced in the treatment zones 3, 4 or 5, to be arranged within the respective treatment zone such that they can likewise be moved relative to the transporting arrangement 11. Furthermore, it is also conceivable for drying fans 51 arranged in the drying zone 7 to be moved relative to the wash ware 10 transported in the transporting direction 9, for example to be pivoted about a pivot axis.

The idea on which the invention is based will be explained in more detail hereinbelow using the example of a clean-water rinsing zone 6 of the conveyor dishwasher 1. As can be gathered from FIG. 1, the top clean-water rinsing system 41 and the bottom clean-water rinsing system 42 are accommodated on a displaceable carriage 49. The carriage 49 may be configured, for example, such that it has, on its underside, a toothing formation in which engages a gearwheel 57 which can be driven via a separate drive 50. Depending on the direction of rotation of the separate drive 50, it is thus possible for the carriage 49 to be displaced within the clean-water rinsing zone 6. Accordingly, it is also possible for the clean-water rinsing systems 41 and 42 accommodated on the carriage 49 to be displaced within the clean-water rinsing zone 6. The carriage 49 can be moved in a displacement direction 39 counter to the transporting direction 9 of the transporting arrangement 11 or in a displacement direction 40 the same as the transporting direction 9 of the transporting arrangement 11.

As seen in the transporting direction 9 of the wash ware 10, a first signal transmitter 53 is located in the entry region to the clean-water rinsing zone 6. The end point of the displacement distance of the transporting carriage in the displacement direction 39, counter to the transporting direction 9, is designated 44. As seen in the direction 9 in which the wash ware 10 is transported through the conveyor dishwasher 1, a second signal transmitter 54 is located in the exit region of the clean-water rinsing zone 6. The end point of the displacement distance 40 in the direction 9 in which the wash ware 10 is transported through the conveyor dishwasher 1 is designated 43. The clean-water rinsing systems 41, 42 accommodated on the displaceable carriage 49 are connected to a pump 46 via a movable water feed 48. The pump 46, which for its part is connected to the machine controller 55, has a solenoid valve 47 arranged upstream of it, it likewise being possible for the solenoid valve to be actuated by the machine controller 55. From the clean-water rinsing zone 6, a return means 45 extends into the tank 36, which is assigned to the pump-action rinsing zone 5 and into which runs excess clean water from the clean-water rinsing zone 6. The clean water which is fed to the top clean-water rinsing system 41 and the bottom clean-water rinsing system 42 by the pump 46 may be pre-heated, i.e. brought to the desired temperature in a boiler, or it may be cold water.

It should be mentioned, for the sake of completeness, that arranged downstream of the clean-water rinsing zone 6, according to the illustration in FIG. 1, is the drying zone 7, within which the wash ware 10 conveyed on the transporting arrangement 11 is dried. The drying zone 7 comprises a drying fan 51 which produces an air flow 52 which comes into contact with the wash ware 10 positioned on the top side of the transporting arrangement 11. The functioning of the conveyor dishwasher 1 proposed according to the invention and illustrated in FIG. 1 is described in more detail hereinbelow:

Following passage through the at least one washing zone 4 and the pump-action rinsing zone 5, the point in time at which the cleaned wash ware 10 enters into the clean-water rinsing zone 6 is sensed by the first signal transmitter 53. The first signal transmitter 53 is connected to the machine controller 55. In the machine controller 55, the point in time at which the cleaned wash ware 10 enters into the clean-water rinsing zone 6, sensed by the first signal transmitter 53, is used to calculate the transporting speed of the transporting arrangement 11 at which the wash ware 10 is transported through the conveyor dishwasher 1 in the transporting direction 9. The separate drive 50, which drives the carriage 49, is brought into operation at the same time as wash ware 10 is detected by the first signal transmitter 53. The drive 50 moves the carriage 49, with the clean-water rinsing systems 41 and 42 accommodated thereon, in the displacement direction 39, i.e. counter to the transporting direction 9 of the wash ware 10, through the clean-water rinsing zone 6. By virtue of the first signal transmitter 53, the solenoid valve 47 and the pump 46 are brought into operation via the machine controller 55, in which case the clean-water rinsing systems accommodated on the carriage 49 are supplied with clean water. The speed at which the carriage 49 is moved can be adjusted optimally, in respect of the clean-water consumption, in dependence on the transporting speed of the wash ware 10 in the transporting direction 9, this speed being determined in the machine controller 55. This ensures that precisely the quantity of clean water which is necessary for completely washing away particles from the wash ware 10 is introduced into the clean-water rinsing zone 6 of the conveyor dishwasher 1.

Once the carriage 49, with the clean-water rinsing systems 41, 42 accommodated thereon, reaches the front end point 44 in the displacement direction 39, counter to the transporting direction 9 of the wash ware 10, the drive 50 assigned to the carriage 49 is reversed and displaces the carriage 49 in the displacement direction 40, i.e. in the transporting direction 9 of the wash ware 10, until the rear end point 43 has been reached. Once the rear end point 43 has been reached, and when the wash ware 10 is detected by the second signal transmitter 54, the solenoid valve 47 is brought into operation by the machine controller 55 and the clean-water delivery pump 46 is switched off, this likewise being initiated by the machine controller 55.

The cleaned, and now rinsed, wash ware 10 enters, from the clean-water rinsing zone 6, into the drying zone 7, in which the wash ware leaving the clean-water rinsing zone 6 is dried and, if appropriate, cooled.

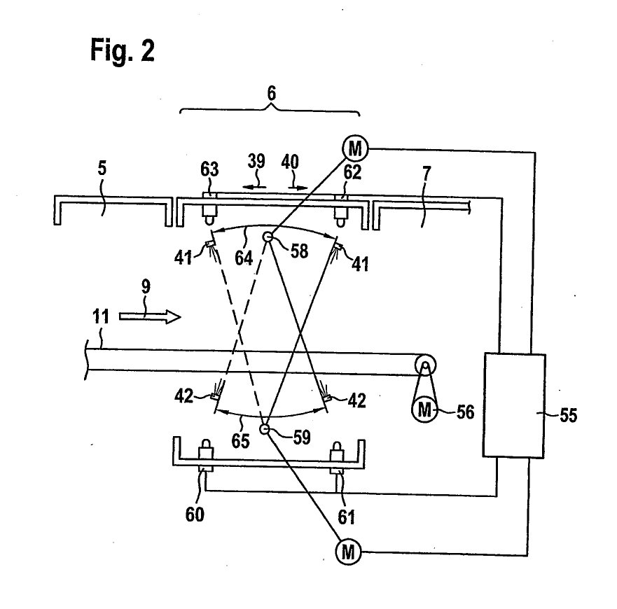

The illustration according to FIG. 2 schematically shows a treatment zone of the conveyor dishwasher in which the spray systems are arranged such that they can be pivoted relative to the transporting direction of the transporting arrangement.

A further variant of the idea on which the invention is based will be explained using the example of the clean-water rinsing zone 6′ which, according to the illustration in FIG. 2, is located between a schematically indicated pump-action rinsing zone 5 and a schematically indicated drying zone 7.

The clean-water rinsing systems 41 and 42 which are illustrated in FIG. 2 are designed such that they can be pivoted about pivot axes 58 and 59, respectively. Each of the pivot axes 58 and 59 is assigned a drive M, each of which are connected to the machine controller 55. The top clean-water rinsing system 41 can be rotated about the pivot axis 59 in the bottom region of the clean-water rinsing zone 6, while the bottom clean-water rinsing system 42 can be rotated about the pivot axis 58 arranged in the top region of the clean-water rinsing zone 6. The pivoting range, of which the end position can be sensed by detectors 60, 61, 62, 63, is indicated, in respect of the top clean-water rinsing system 41, by the circle-arc segment 64 and, in respect of the bottom clean-water rinsing system 42, by the circle-arc segment designated 65.

The transporting arrangement 11 in FIG. 2 conveys wash ware (not illustrated) through the clean-water rinsing zone 6 in the transporting direction 9. The drive of the transporting arrangement 11, preferably designed as an endless, circulating conveying belt, is designated 56. The wash ware 10 conveyed by the transporting arrangement 11 is wetted from the top side and from the underside by the two clean-water rinsing systems 41 and 42, which are located opposite one another in the clean-water rinsing zone 6.

In respect of the top clean-water rinsing system 41, which can be pivoted about the pivot axis 59, the presence of wash ware in the entry region to the clean-water rinsing zone 6 is sensed by the detector 63. The detector 63, which is connected to the machine controller 55, determines—in a manner analogous to the variant according to FIG. 1—the transporting speed at which the wash ware is transported through the clean-water rinsing zone 6 in the transporting direction 9. When the detector 63 detects wash ware in the entry region to the clean-water rinsing zone 6, the clean-water pump (not illustrated in FIG. 2) and the associated solenoid valve are actuated by the machine controller 55, and the drive M assigned to the pivot axis 59 is switched on. The top clean-water rinsing system 41 thus pivots in the counterclockwise direction toward the first displacement region 39, counter to the direction 9 in which the wash ware 10 is transported through the clean-water rinsing zone 6. The same applies to the bottom clean-water rinsing system 42, which is arranged such that it can be moved about the pivot axis 58. As has already been described above, this bottom system, triggered by the bottom detector 60, can be pivoted counter to the transporting direction 9 of the wash ware 10 as soon as the detector 60 has detected the presence of wash ware in the entry region to the clean-water rinsing zone 6 and, accordingly, the supply of clean water to the bottom clean-water rinsing system 42 has been triggered by a solenoid valve (cf. illustration according to FIG. 1) being actuated by the machine controller 55. The angular speed at which the clean-water rinsing systems 41 and 42 are moved about their pivot axes 58 and 59 in each case is advantageously optimized by the machine controller 55 in dependence on the previously determined speed at which the wash ware is transported through the clean-water rinsing zone 6. This ensures that the wash ware which is cleaned, and is to be rinsed, by the clean-water rinsing zone 6 is rinsed by a sufficient quantity of clean water to ensure that particles are completely washed away from the wash ware which is to be rinsed.

The clean water which, according to FIG. 2, is applied to the wash ware via pivotable clean-water rinsing systems 41 and 42 may be both cold clean water and clean water which has been heated by means of a boiler (not illustrated in FIG. 2).

Upon detection of the wash ware in the exit region of the clean-water rinsing zone 6 by the detectors 62 and 61, the respective clean-water rinsing systems 41 and 42 are returned to their starting position, i.e. in the direction of the exit region, i.e. in the direction of the arrow 40 of the clean-water rinsing zone 6, and the clean-water pump is deactivated by the machine controller 55.

The solution which is proposed according to the invention, and has been described with reference to the two variants illustrated in FIG. 1 and FIG. 2, allows the quantity of clean water which is introduced into a conveyor dishwasher 1, for example, within the clean-water rinsing zone 6 to be optimally adapted to the transporting speed of the wash ware 10. By virtue of the solution proposed according to the invention, precisely enough clean water—be this heated water or cold water—is applied to the wash ware 10 as to ensure that particles still adhering to the wash ware 10 which has to be rinsed are washed away. Furthermore, the solution proposed according to the invention makes it possible for the introduction of chemical detergents into the conveyor dishwasher 1 to be reduced to the amount which is absolutely necessary, and this reduces, overall, the damage to the environment caused by waste-water contamination.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conveyor dishwasher comprising:
a transporting arrangement for wash ware having a plurality of treatment zones through which the wash ware is transported in a transporting direction; and
at least one spray system being provided in the treatment zones, the spray system configured to be moved relative to the transporting direction of the wash ware, the spray system having a the movement capability within the respective treatment zone configured to allow the spray system at least one of the following movements:
a displacement by a displacement distance counter to the transporting direction of the wash ware;
a displacement by a displacement distance in the transporting direction of the wash ware; or
a movement counter to the transporting direction of the wash ware about a pivot axis.

2. The conveyor dishwasher as claimed in claim 1, further comprising a rinsing system for facilitating that clean water is moved relative to the transporting direction of the wash ware.

3. The conveyor dishwasher as claimed in claim 1, wherein the at least one spray system within the respective treatment zone is moved about pivot axes within a pivoting range in the transporting direction of the wash ware.

4. The conveyor dishwasher as claimed in claim 1, further comprising:
a first signal transmitter, which senses a point in time at which the wash ware reaches a respective treatment zone; and
a machine controller for determining, based on an input from the first signal transmitter, a speed at which the wash ware is transported through the conveyor dishwasher.

5. The conveyor dishwasher as claimed in claim 4, wherein the first signal transmitter causes at least one spray system within a respective treatment zone and at least one pump that acts on the respective spray system to be switched on.

6. The conveyor dishwasher as claimed in claim 4, wherein the first signal transmitter senses the presence of wash ware.

7. The conveyor dishwasher as claimed in claim 1, wherein the at least one spray system is arranged on a displaceable carriage.

8. The conveyor dishwasher as claimed in claim 7, wherein the carriage is assigned a drive that is operated by the machine controller, and is activated by a first signal transmitter and is reversed by a second signal transmitter.

9. The conveyor dishwasher as claimed in claim 7, wherein the carriage has a movable water feed for supplying a clean-water rinsing systems with clean water.

10. The conveyor dishwasher as claimed in claim 7, wherein the displaceable carriage has a toothing formation which is driven via a transmission element driven by the reversible drive.

11. The conveyor dishwasher as claimed in claim 1, wherein the spray systems, which are pivoted about respective pivot axes, are each driven via a separate drive.

12. The conveyor dishwasher as claimed in claim 11, wherein the treatment zone contains detectors that sense an entry of wash ware into the respective treatment zone and activate a supply of the spray systems by operating the pumps and, when an exit region of the respective treatment zone is reached, initiate a return movement of the spray systems that is moved about the respective pivot axes.
